(19) United States
(12) Patent Application Publication
(10) Pub. No.: US 2013/0317764 A1
(43) Pub. Date: Nov. 28, 2013

(54) APPARATUS AND METHOD FOR MONITORING A LIQUID PRODUCT IN A SEALED VESSEL

(71) Applicants: Ashok Kumar, Lexington, KY (US); Siddhartha Bhattacharyya, Lexington, KY (US); Patrick J. Garrity, Frankfort, KY (US)

(72) Inventors: Ashok Kumar, Lexington, KY (US); Siddhartha Bhattacharyya, Lexington, KY (US); Patrick J. Garrity, Frankfort, KY (US)

(73) Assignee: KENTUCKY STATE UNIVERSITY, Frankfort, KY (US)

(21) Appl. No.: 13/479,966

(22) Filed: May 24, 2012

(51) Int. Cl. G06Q 40/00; G01F 23/296; G06F 19/00; G01F 23/284

(52) U.S. Cl. 702/51; 702/55; 702/54

(57) ABSTRACT

An apparatus and method are provided for monitoring a liquid product held in a sealed vessel and determining taxes that will be owed on the liquid product at a future dumping time. The apparatus and method also allow one to determine fault conditions within a sealed vessel as well as to determine when the product in the sealed vessel is ready for use.

### TECHNICAL FIELD

This document relates generally to an apparatus and method of monitoring liquid product in sealed vessels and, more particularly, to an apparatus for monitoring distilled spirits in a sealed vessel.

### BACKGROUND SECTION

The distilling of alcoholic beverages such as bourbon, whiskey, vodka, rum and the like has been ongoing for centuries. The industry relies on many time honoured traditions and, as a result, is very labor intensive. For example, aging barrels full of distilled spirits, such as bourbon, are manually inspected for leaks. Individuals actually taste test product from individual barrels in order to determine which barrels should be blended together to create the ultimate product. Further, distillers utilize annual budgets on what they estimate the federal excise tax will be when product is dumped from the aging barrels. Typically, distillers use an evaporation (“angels share”) loss of 4% per year per barrel to make this estimate.

The present apparatus and method allows distillers to make more precise tax estimates based upon accurate volume measurements. This results in a number of benefits including:
(1) determination of more precise federal excise tax budget forecast;
(2) improvement in sales and marketing forecasts based on actual upcoming production volumes; and
(3) ability to modify production schedules based upon more accurate finished product volume estimates.

In addition, the present apparatus and method allow distillers to quickly identify any barrel leak whether it be a liquid leak or an air leak. Corrective action may then be promptly taken to address and resolve any problem. Thus, potential hazards and/or product losses may be quickly minimized or eliminated. Further, this is achieved in a cost effective manner with minimal man hours.

Still further, the present apparatus and method advantageously allow a distiller to accurately and effectively monitor the distilled spirits held in sealed aging vessels or barrels so as to determine when those distilled spirits fall within a desired flavour profile and are thus ready for dumping, further processing and bottling.

### Summary Section

In accordance with the purposes and advantages disclosed herein, an apparatus is provided for monitoring a liquid product held in a sealed vessel and more accurately determining taxes that will be owed on that liquid product at a future time when that product is dumped from the vessel for use. The apparatus comprises a sensor assembly held in the vessel with the liquid product and a computing device external to the vessel. The sensor assembly includes a sensor section, a communication section, and a power section. The sensor section includes a liquid level sensor that determines a level of liquid product held in the vessel. The communication section of the sensor assembly communicates over a communication network so as to provide product data from the sensor section to the computing device. The computing device then determines the volume of liquid product in the sealed vessel, the taxes that will be owed on the product at dumping time or both based upon that product data.

In some embodiments the liquid level sensor is a laser liquid level sensor. In some embodiments the liquid level sensor is an ultrasonic liquid level sensor. In some embodiments the sensor assembly is held in a housing inside the vessel. In some embodiments that housing is liquid impervious so as to prevent contact between the sensor section and the liquid product. In some embodiments the housing allows air in the internal head space between the vessel and the liquid product to reach at least a portion of the sensor section. That sensor section may include at least one of a temperature sensor, a pressure sensor and a humidity sensor. Optionally the sensor assembly may further include a volatile organic compound sampling port.

In one particular useful embodiment the sensor section includes a temperature sensor, a pressure sensor, a humidity sensor and a liquid level sensor and product data from all four sensors are communicated to the computing device over the communication network by the communication section. The computing device then compares that product data to known data profiles for fault conditions to identify a fault condition if in fact it exists in the vessel being monitored. Such a fault condition includes but is not limited to a liquid product leak, a head space air leak and combinations thereof. Further the computing device compares the product data to known data profiles for desired final product to identify when the liquid product in the sealed vessel is ready for use.

In accordance with another aspect, a distilled spirits monitoring system is provided. The distilled spirits monitoring system comprises a plurality of sealed vessels holding distilled spirits, a sensor assembly held in each of the plurality of sealed vessels with the distilled spirits and a computing device external to the plurality of sealed vessels.

Still further, a method of monitoring a liquid product in a sealed vessel is provided. The method includes the steps of: (1) receiving, by a computing device, product data including liquid level data from a communication section of a sensor assembly contained in the sealed vessel with the liquid product; (2) determining by the computing device, a total amount or volume of liquid product contained in the sealed vessel as the volume varies over time; (3) completing, by the computing device, the determination for a plurality of sealed vessels containing liquid product; and (4) determining by the computing device, a total amount of taxes that will be owed on the liquid product held in the plurality of sealed vessels at a future time when the product is dumped from those vessels. In some embodiments the method further includes the steps of: (5) receiving, by the computing device, product data including temperature, humidity and pressure data for the liquid product held in the sealed vessel; (6) comparing by the computing device, the product data to known data profiles for fault conditions to identify a fault condition within the sealed vessel; and (7) comparing, by the computing device, the product data to known data profiles for a desired final product to identify when the liquid product in the sealed vessel has a desired taste profile and is ready for use.

### BRIEF DESCRIPTION OF THE DRAWING FIGURES

The accompanying drawings incorporated herein and forming a part of the specification, illustrate several aspects of the present apparatus and together with the description serve to explain certain principles of the apparatus. In the drawings:

FIG. 1 shows a schematic of the current apparatus.

FIG. 2 shows a detailed schematic of the computing device.

FIG. 3 is a schematic illustration of the distilled spirits monitoring system.

FIG. 4 is a flow diagram exemplary of the monitoring method.

FIG. 5a is a pressure vs. time plot illustrating pressure fluctuations within a sealed barrel over several years of “aging” under normal conditions.

FIG. 5b is a pressure vs. time plot indicating a leak in the fluid contents of the barrel being monitored.

FIG. 5c is a pressure vs. time plot indicating a leak in the headspace of the barrel being monitored.

FIG. 6 is an illustration of an exemplary user interface showing an alert message.

Reference will now be made in detail to the present preferred embodiments of the apparatus, examples of which are illustrated in the accompanying drawings.

### DETAILED DESCRIPTION

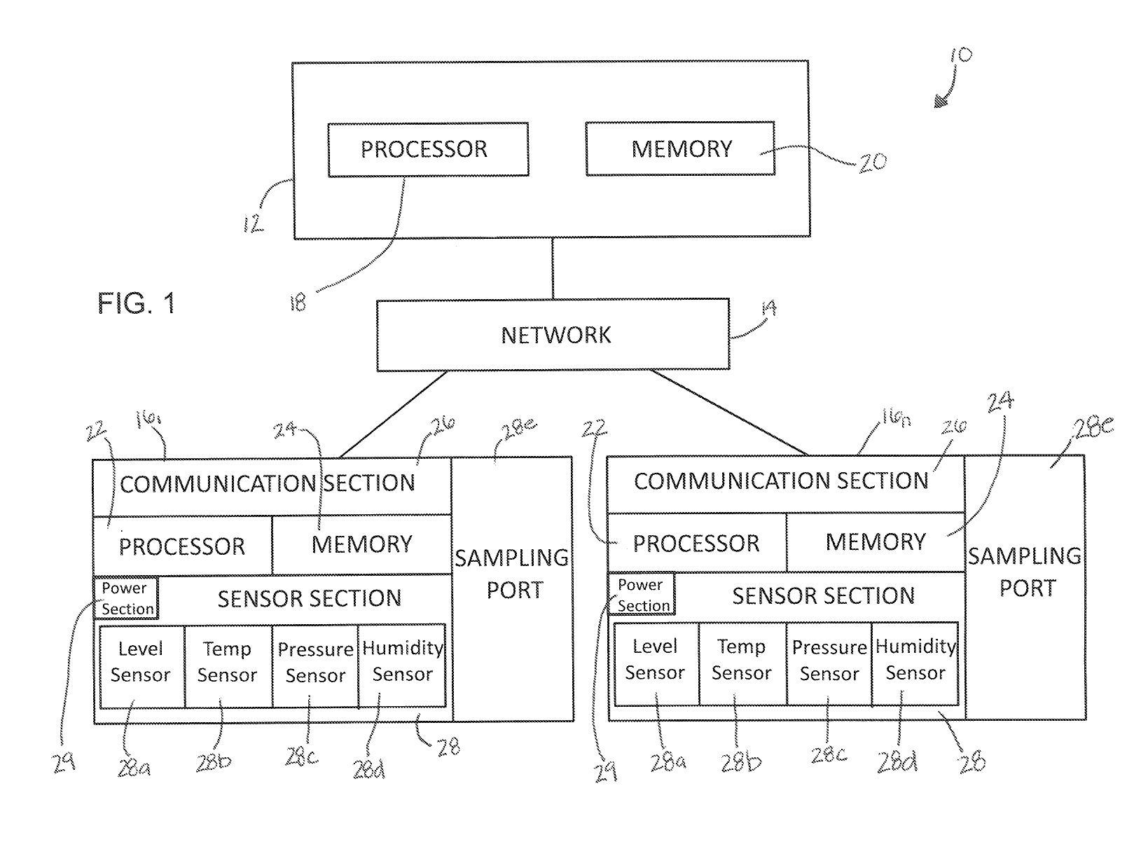

Reference is now made to FIG. 1 illustrating an apparatus 10 for monitoring a liquid product held in a sealed vessel and more accurately determining taxes that will be owed on that liquid product when it is dumped. The apparatus 10 is a computing system environment which may comprise a base unit or computing device 12 that communicates over a network 14 with a sensor assembly 16₁. Typically, the computing device 12 communicates with multiple sensor assemblies schematically illustrated as 16₁-16ₙ. The computing device 12 may include a processor 18 and a memory 20. The memory 20 may be utilized to store, for example, instructions that cause the processor 18 to perform various tasks and steps of the method described in detail below. The memory 20 may also be utilized to store, for example, known data profiles for (1) fault conditions, (2) a desired final product and (3) the like.

Each sensor assembly device 16₁, 16ₙ may include a processor 22, a memory 24, a communication section component 26 and a sensor section 28. A power section 29, such as a battery, provides the necessary energy to power the processor 22, memory 24, communication section 26 and sensors in the sensor section 28. The memory 24 may be utilized to store instructions that when executed by the processor 22, cause the sensor assembly 16₁, 16ₙ to operate in accordance with any function described herein. For example, memory 24 may include instructions for periodically measuring the temperature, pressure, humidity and liquid level of a liquid product, such as a distilled spirit (e.g. bourbon, rum, vodka, whisky, cognac) held in a sealed vessel such as a barrel. In order to accomplish this, the sensor section 28 includes a series of sensors including, but not necessarily limited to, a liquid level sensor 28a, a temperature sensor 28b, a pressure sensor 28c and a humidity sensor 28d. The sensor section 28 may also include an optional volatile organic compound sampling port 28e.

The communications component 26 interfaces with the processor 22 and facilitates wired or wireless communication with external systems such as the computing device 12 over the network 14. The network 14 may comprise any network of a type known in the art including but not limited to a local area network (LAN), a wide area network (WAN), a wireless network or any other network or network of networks including that generally known as the internet. While not illustrated, each sensor assembly 28 may include a GPS/geolocator component that includes a location app of a type known in the art. Alternatively, or in addition, the GPS/geolocator component may include a global positioning system (GPS) receiver. Regardless of its configuration the GPS/geolocator component is capable of accurately identifying the geographic position of sensor assembly 16₁, 16ₙ. Such a GPS/geolocator component can be utilized to quickly locate the sensor assembly 16₁, 16ₙ when, for example, a fault condition such as a leak in a sealed vessel is indicated by the sensor assembly 28.

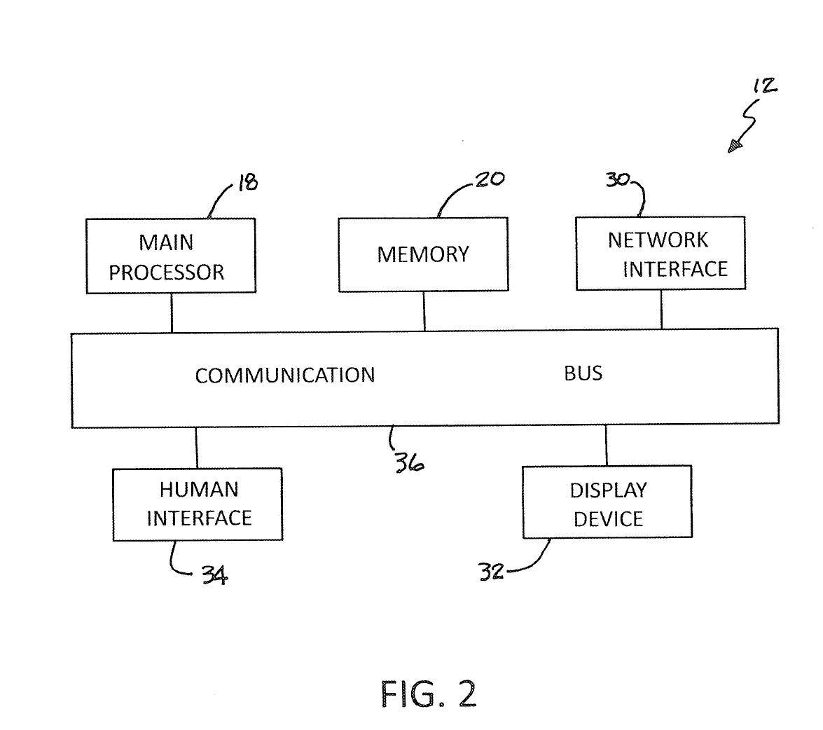

Reference is now made to FIG. 2 further illustrating the computing system environment including the base unit or computing device 12. As illustrated the computing device 12 includes one or more processors 18 and one or more memories 20. The computing system environment 10 also includes one or more network interfaces 30 and one or more input/output devices such as display devices 32 and human interfaces 34. As should be appreciated, all of these components communicate with each other over a communications bus 36.

In one particularly useful embodiment, the computing device 12 takes the form of a server. It should be appreciated, however, that substantially any computing device having a processor can be utilized. Thus, the computing device 12 may also take the form of a laptop, digital assistant, tablet computer, personal computer, or other computing device able to execute computer readable instructions.

The processor 18 may be referred to as a main processor or central processing unit (CPU). The processor 18 may include a single or multiple processing cores. Where two or more cores are provided, the cores may be capable of operating in parallel.

The memory 20 may comprise any number and combination of memory devices including but not limited to cache memory, such as static random access memory (SRAM), dynamic random access memory (DRAM), enhanced DRAM or the like. Any storage repository or non-transitory machine readable storage medium of a type known in the art may also be used. The processor 18 accesses the memory 20 through the communications bus 36 to access any application or data stored thereon including, but not limited to, any computer readable instructions.

The network interface 30 may be used to interface with any network 14 including but not limited to the internet. The input/output devices may comprise one or more computer monitors, printers or other display devices 32 as well as human interfaces 34 including but not limited to keyboards, mice, pointers, microphones, speakers or the like.

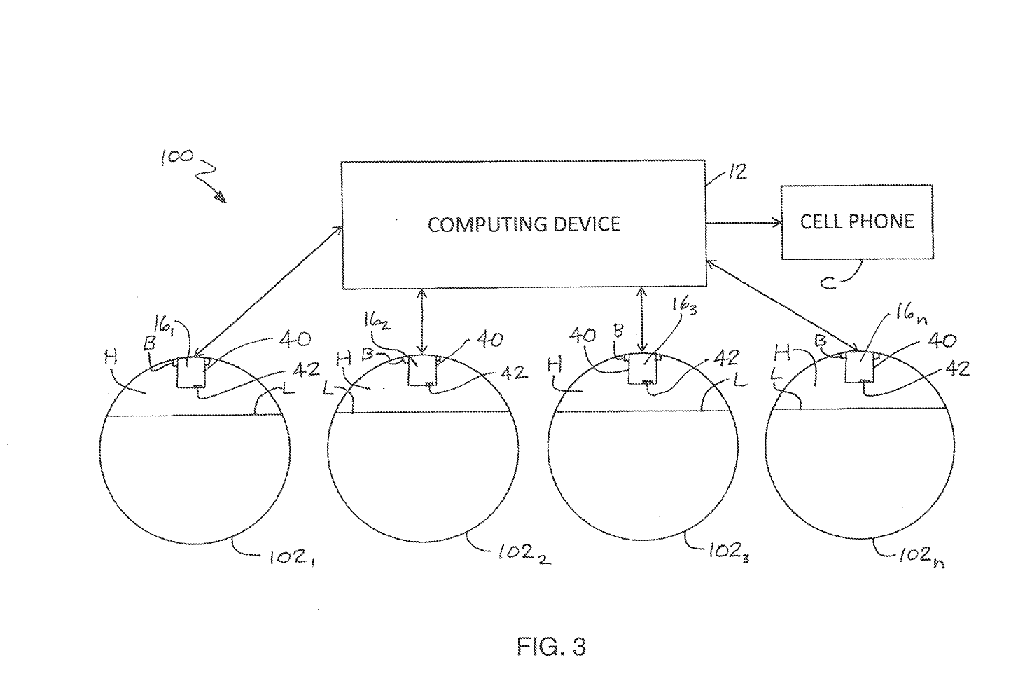

A distilled spirits monitoring system 100 is illustrated in FIG. 3. The system 100 includes a plurality of sealed vessels such as bourbon barrels 102₁-102ₙ. A sensor assembly 16₁, 16ₙ is positioned in each of the barrels 102₁-102ₙ. In one particularly useful embodiment, each sensor assembly 16₁, 16ₙ includes a liquid impervious housing 40 that prevents any direct contact between the sensors 28a-28d (see also FIG. 1) and the liquid product, in this case bourbon, held within the barrels 102₁-102ₙ. This protects the integrity of the liquid product and prevents any interference in the long-established and proper aging process.

The housing 40 includes any necessary sealed window 42 (such as a quartz window for a laser) to allow the level sensor 28a to function properly. Such a level sensor 28a may comprise, for example, an ultrasonic liquid level sensor or a laser liquid level sensor of a type known in the art. The housing 40 allows air to pass to at least the pressure and humidity sensors 28c and 28d so that the pressure and humidity of the head space H in the barrel 102₁-102ₙ above the level L of the liquid bourbon can be measured and monitored.

In some embodiments, the sensor assembly 28 is mounted on a bung B that is used to seal the barrel 102₁-102ₙ, after the barrel has been filled with liquid to the desired level. The particular sensor assembly 28 is then identified with that particular barrel 102₁-102ₙ until the aging process is completed and the bourbon in the barrel is ready for further processing or bottling.

Distilled spirits, such a bourbon are aged in barrels 102₁-102ₙ often for many years. Over that time period, the liquid level in the barrel will change due to a number of factors. For example, a fault condition may occur and the sealed barrel 102₁-102ₙ could develop a leak below the liquid level in the barrel thereby leading to bourbon leaking from the barrel. Even under optimum conditions where no liquid leak occurs, over time at least some bourbon is absorbed into the wood of the barrel thereby lowering the liquid level. Some volatile liquid product is also lost to evaporation. Advantageously, the liquid level sensor 28a allows the monitoring of the liquid level in the barrel 102₁-102ₙ over time. Thus, it is possible to quickly detect any liquid leaks and the actual amount of bourbon in a particular barrel 102₁-102ₙ at any time.

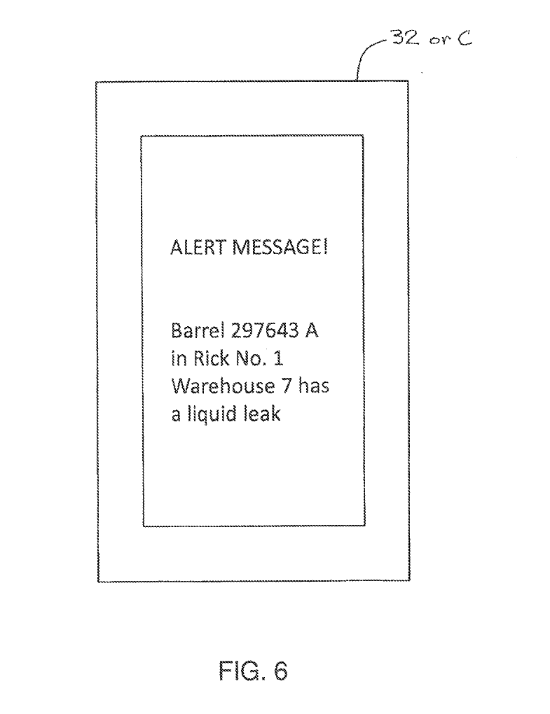

When a leak condition is detected by the computing device comparing the sensed liquid level in the barrel 102₁-102ₙ to a known data profile for such a fault condition, the computing device generates an alert message. That alert message may be provided on the display device 32 and/or sent over a network to, for example, the cell phone of distillery personnel. FIG. 6 illustrates such an alert message on a cell phone C indicating that barrel 297643A in Rick 1 Warehouse 7 has a liquid leak. The distillery employee can then immediately locate the leaking barrel and take any appropriate action required to resolve the problem.

The ability of liquid level sensor 28a to accurately determine the level of liquid L in the barrel 102₁-102ₙ at any time allows the computing device to also accurately determine the amount of bourbon within any barrel 102₁-102ₙ. This can be done for all of the barrels 102₁-102ₙ at a distillery in which bourbon is being aged. Thus, the computing device 12 can accurately determine the total amount or volume of distilled/aging spirits such as bourbon contained in all of the aging barrels 102₁-102ₙ at any given time. This information can be used to allow the distillery to more accurately estimate taxes that will be due at a future time when the barrels are dumped. As a result, the distillery can better budget for taxes, improve sales and marketing forecasts based upon actual, measured upcoming production volumes and better modify production schedules based upon finished product volume estimates.

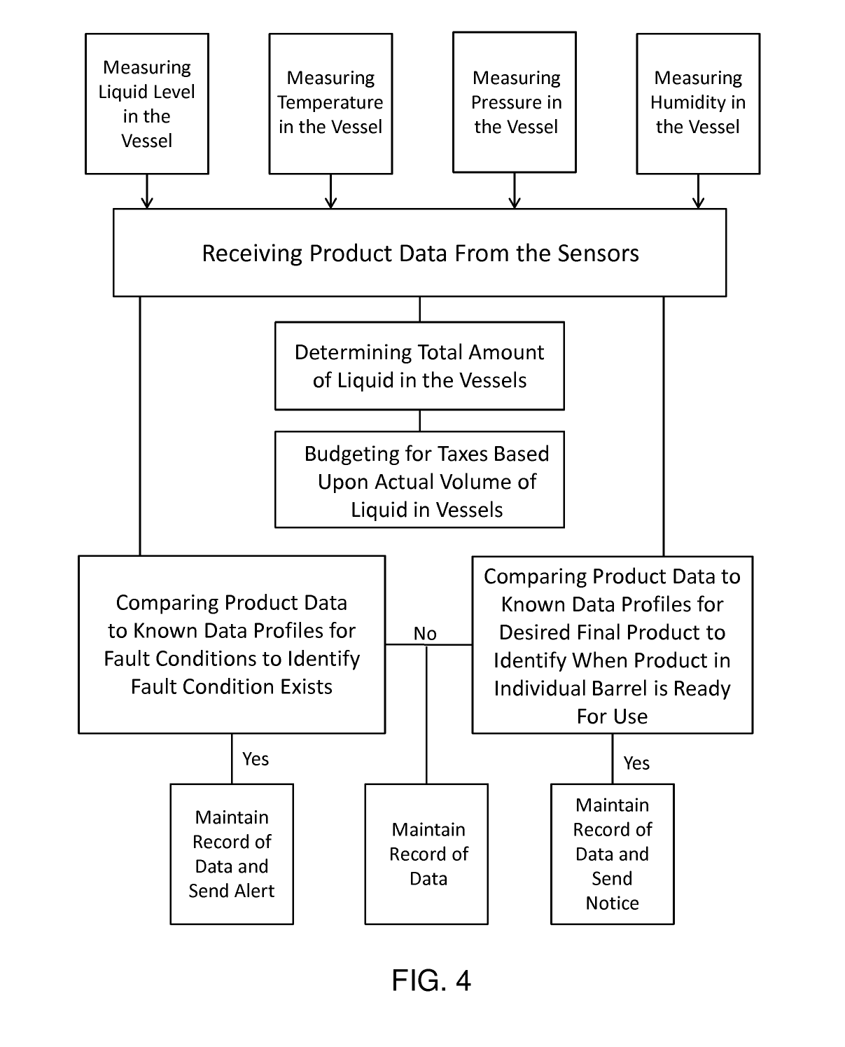

Reference is now made to FIG. 4 which is a flow diagram exemplary of the current method. As illustrated, the sensor assemblies 28 in the barrels 102₁-102ₙ periodically take liquid level, temperature, pressure and humidity readings inside the barrels and send that data over the network 14 to a database of the computing device 12. This may be done automatically on a periodic basis by a timing function in the processor 22 of each sensor assembly 16₁, 16ₙ, by instruction received from the computing device 12 via communication with the processor 22 over the network 14 or both. In some embodiments, the computing device 12 then compares the product data transmitted by the sensor assemblies 28 to known data profiles for fault conditions in order to identify a fault condition within any particular sealed vessel. In addition, in some embodiments the computing device 12 compares the product data from the barrels 102₁-102ₙ to known data profiles for a desired final product to identify when the liquid product in each of the sealed vessels has achieved a desired taste profile and is, therefore, ready for use or bottling.

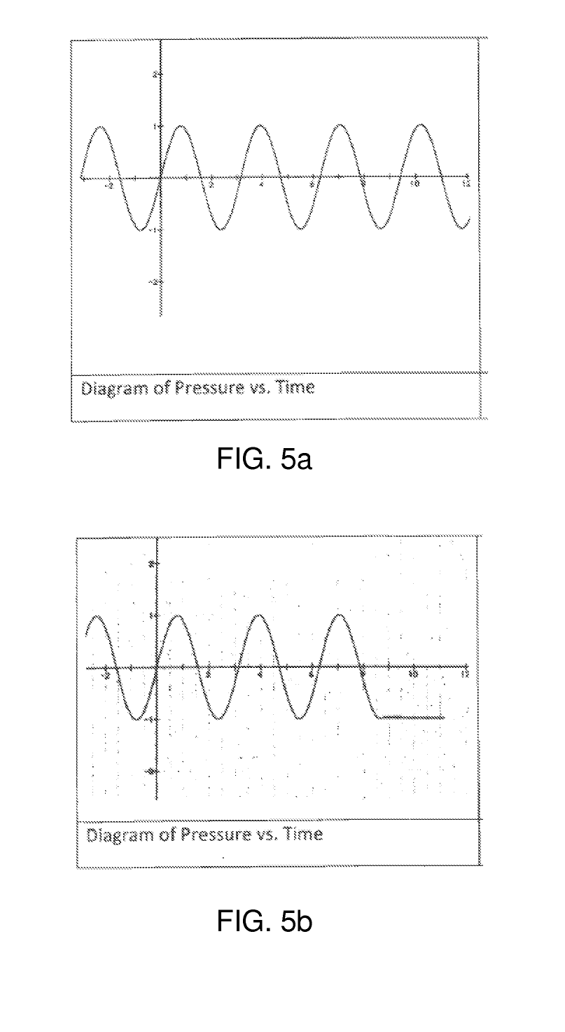

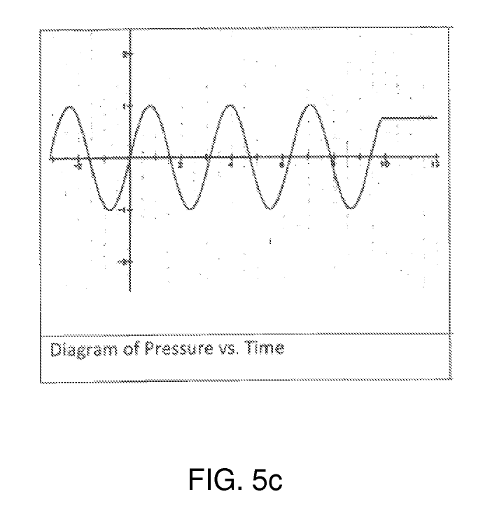

FIG. 5A illustrates a pressure vs. time plot or curve showing the pressure fluctuations within a sealed barrel over several years of aging under normal conditions. High pressure readings result in the summer months when the temperature inside the barrels 102₁-102ₙ increases. Low pressure readings are generally found in the winter months when the temperature inside the barrels 102₁-102ₙ decreases.

FIG. 5B illustrates pressure readings or product data indicating a leak in the fluid contents of a particular barrel. As illustrated by the pressure vs. time curve, a decrease in pressure occurs at approximately 8.5 on the time axis. This loss in pressure is characteristic of a liquid leak. Such a liquid leak is quickly confirmed by the liquid level sensor 28a.

FIG. 5C is a pressure vs. time plot wherein the pressure readings for product data indicates a leak in the “head space” of the barrel: in other words, this is an air leak. As shown by the pressure vs. time curve a decrease in barrel pressure occurs at approximately 9.75 on the time line. The pressure restores to ambient pressure which is the same as the pressure outside of the barrel. This loss in pressure and slow equilibration is characteristic of a “headspace” or air leak within the barrel. Such air leaks, which may be quickly confirmed by the liquid level sensor 28a indicating no change in liquid level inside the barrel, can have a very adverse effect on the flavor profile of the bourbon contained in the barrel. Accordingly, an appropriate headspace leak alert is issued for this fault condition so that the distillery personnel may take corrective action and potentially avoid loss of product in the affected barrel.

As previously noted at any time the level of liquid and, therefore, the amount or volume of bourbon held in each barrel 102₁-102ₙ can be accurately determined by data from the liquid level sensors 28a transmitted to the computing device 12. Thus the distillery can quickly make more accurate tax payment estimates on the bourbon held in all of the barrels. This greatly aids budgeting for the excise taxes.

In summary, numerous benefits result from employing the concepts of the present apparatus and method. The present apparatus and method effectively provide an automated fluid leak detection system that constantly compares physical parameter data obtained by the sensor assemblies 28 for all of the aging barrels 102₁-102ₙ at the distillery. An alert is generated by the computing device 12 when any product data measurements fall outside of known or expected measurement ranges. Thus it is possible to detect a fluid leak that results in the loss of product and the generation of flammable ethanol fumes in the warehouse environment.

The apparatus and method also provide an automated “headspace” or air leak detection system. Thus, the apparatus and method allow one to detect the type of leak that causes distilled spirits to have an undesirable taste or odor thereby otherwise rendering the product in the barrel useless. By providing an early alert to the problem, the distillery can address the situation and potentially save the product thereby reducing waste and increasing production efficiency and profit margin for the distillery.

In accordance with yet another aspect of the apparatus and method, it is possible to utilize pressure, temperature and humidity data from the aging barrels 102₁-102ₙ to predict the flavor profile of the aging spirit or bourbon. Flavor profile is a term of art in the distillery industry that refers to the overall taste/fragrance experience with a particular distilled spirits. Master distillers use the flavor profile to determine the best use for the contents of a particular barrel. This ability helps increase the distillery's profit margin by providing useful information respecting which barrels of product should be blended together to achieve a final product of desired taste and when to best use the product within each and every bottle of distilled spirits.

In addition, by using the physical parameter measurements throughout an entire year, the apparatus and method allow the distillery to make more accurate accounts of the volume of distilled spirits contained in the aging barrels 102₁-102ₙ. This provides the distillery with a number of advantages as it allows more accurate budgeting for taxes, more accurate sales and marketing forecasts and more effective modification of production schedules to meet finished product volume targets.

The foregoing has been presented for purposes of illustration and description. It is not intended to be exhaustive or to limit the embodiments to the precise form disclosed. Obvious modifications and variations are possible in light of the above teachings. For example, the apparatus 10 and monitoring system 100 could also be used by the wine industry. All such modifications and variations are within the scope of the appended claims when interpreted in accordance with the breadth to which they are fairly, legally and equitably entitled.

What is claimed:

1. An apparatus for monitoring a liquid product held in a sealed vessel and more accurately determining taxes that will be owed on said liquid product at a future dumping time, comprising:
a sensor assembly held in said vessel with said liquid product and a computing device external to said vessel;
said sensor assembly including a sensor section, a communication section, and a power section wherein said sensor section includes a liquid level sensor that determines a level of liquid product held in said vessel;
said communication section of said sensor assembly communicating over a communication network so as to provide product data from said sensor section to said computing device; and
said computing device determining volume of liquid product held in said sealed vessel, taxes that will be owed on the liquid product in said sealed vessel at dumping time or both based upon said product data.

2. The apparatus of claim 1 wherein said liquid level sensor is a laser liquid level sensor.

3. The apparatus of claim 1, wherein said liquid level sensor is an ultrasonic liquid level sensor.

4. The apparatus of claim 1, wherein said sensor assembly is held in a housing inside said vessel.

5. The apparatus of claim 4, wherein said housing is liquid impervious so as to prevent contact between said sensor section and said liquid product.

6. The apparatus of claim 5, wherein said housing allows air in an internal headspace between said vessel and said liquid product to reach at least a portion of said sensor section.

7. The apparatus of claim 6, wherein said sensor section further includes at least one of a temperature sensor, a pressure sensor, and a humidity sensor.

8. The apparatus of claim 7, wherein said sensor assembly further includes a volatile organic compound sampling port.

9. The apparatus of claim 1, wherein said sensor section further includes a temperature sensor, a pressure sensor and a humidity sensor and product data from said temperature sensor, pressure sensor, humidity sensor and liquid level sensor are communicated to said computing device over said communication network by said communication section.

10. The apparatus of claim 9, wherein said computing device compares said product data to known data profiles for fault conditions to identify a fault condition.

11. The apparatus of claim 10, wherein said fault condition is selected from a group consisting of a liquid product leak, a headspace air leak and a combination thereof in said sealed vessel.

12. The apparatus of claim 9, wherein said computing device compares said product data to known data profiles for a desired final product to identify when said liquid product in said sealed vessel is ready for use.

13. The apparatus of claim 1, wherein said liquid product is bourbon and said sealed vessel is a bourbon barrel.

14. A distilled spirits monitoring system, comprising:
a plurality of sealed vessels holding distilled spirits;
a sensor assembly held in each of said plurality of sealed vessels with said distilled spirits;
a computing device external to said plurality of sealed vessels;
each said sensor assembly including a sensor section and a wireless communication section wherein said sensor section includes a liquid level sensor that determines a level of liquid product held in said sealed vessel;
said communication section of said sensor assembly communicating over a communication network so as to provide product data from said sensor section to said computing device; and
said computing device determining volume of said liquid product held in said plurality of sealed vessels, taxes that will be owed on the liquid product in said plurality of sealed vessels at dumping time or both based upon said product data.

15. The apparatus of claim 14, wherein said sensor section further includes a temperature sensor, a pressure sensor and a humidity sensor and product data from said temperature sensor, pressure sensor, humidity sensor and liquid level sensor are communicated to said computing device over said communication network by said communication section.

16. The apparatus of claim 15, wherein said computing device compares said product data to known data profiles for fault conditions to identify a fault condition.

17. The apparatus of claim 16, wherein said fault condition is selected from a group consisting of a liquid product leak, a headspace air leak and a combination thereof in said sealed vessel.

18. The apparatus of claim 14, wherein said computing device compares said product data to known data profiles for a desired final product to identify when said liquid product in said sealed vessel is ready for use.

19. A method of monitoring a liquid product in a sealed vessel, comprising;
receiving, by a computing device, product data including liquid level data from a communication section of a sensor assembly contained in said sealed vessel with said liquid product;
determining, by said computing device, a total volume of liquid product contained in said sealed vessel as said volume varies over time;
completing, by said computing device, said determination for a plurality of sealed vessels containing liquid product; and
determining, by said computing device, a total amount of taxes that will be owed on said liquid product held in said plurality of sealed vessels at dumping time.

20. The method of claim 19, further including:
receiving, by said computing device, product data including temperature, humidity and pressure data for said liquid product held in said sealed vessel;
comparing, by said computing device, said product data to known data profiles for fault conditions to identify a fault condition within said sealed vessel; and
comparing, by said computing device, said product data to known data profiles for a desired final product to identify when said liquid product in said sealed vessel is ready for use.
